(19) United States
(12) Patent Application Publication
(10) Pub. No.: US 2002/0069373 A1
(43) Pub. Date: Jun. 6, 2002

(54) Safe shutdown device for an uninterruptible power supply (UPS) system and method for safely shuting down a UPS system

(76) Inventor: Jesse Zhuo, Tainan Hsien (TW)

Correspondence Address: BIRCH STEWART KOLASCH & BIRCH, PO BOX 747, FALLS CHURCH, VA, 22040-0747, US

(21) Appl. No.: 09/820,665

(22) Filed: Mar. 30, 2001

(30) Foreign Application Priority Data
Dec. 4, 2000 (TW) 89125798

(51) Int. Cl. G06F 1/26; G06F 1/28; G06F 1/30

(52) U.S. Cl. 713/324

(57) ABSTRACT

This specification discloses a safe shutdown device for an uninterruptible power supply (UPS) system, which includes a switch module, a counting module, and a shutdown module. The switch module generates an OFF signal to the central processing unit (CPU) of the UPS. After processing, the OFF signal is converted into a first shutdown signal and output to external equipment so as to shut down the external equipment. At the same moment, the CPU of the UPS sends out a second shutdown signal to the counting module to perform counting and generate counting values. When the counting value reaches a predetermined time value, a third shutdown signal is output to the shutdown module. The shutdown module generates a power supply shutdown signal according to the third shutdown signal so as to shut down the UPS itself.

### BACKGROUND OF THE INVENTION

1. Field of Invention

The invention relates to a shutdown device for an uninterruptible power supply (UPS) system and a method for safely shutting down a UPS system. More particularly, the invention relates to a safe shutdown device for a UPS system.

2. Related Art

The UPS is used to provide clean and stable power to all types of equipment. Therefore, almost all important apparatuses (such as computer systems) are equipped with a UPS to ensure safe operations of the systems.

A conventional UPS 7 is shown in FIG. 1. It includes a charging unit 71, a power storage unit 72, a voltage detection and control unit 73, a power relay unit 75, and an input/output (I/O) control unit 76. The charging unit 71 connects to an external power supply and charges the power storage unit 72. The voltage detection and control unit 73 connects to the power supply to detect the input power voltage. The detection result is transmitted to the CPU 75. The CPU 75 then controls the voltage detection and control unit 73 according to the detection result so as to output the power stored in the power storage unit 72 through the power relay unit 74 to external equipment. In addition, the I/O control unit 76 controls the I/O information between the external equipment and the UPS 7.

The most popular application of the UPS is for computer apparatuses to avoid data loss or damage caused by any power failure.

In spite of the fact that the conventional UPS can provide clean and stable power to all types of equipment it nevertheless cannot shut down the power used by the equipment and the power of the UPS itself for the user under emergency situations. In particular, when the UPS connects to several computers, the process of shutting itself down must be performed on a one by one basis. The user has to spend a lot of time to safely turn off the power for all of the equipment. Therefore, it is highly desirable to provide a UPS that can safely and entirely turn off all or some predetermined apparatuses connected to the UPS and then shut down the power of the UPS through simple operations.

### SUMMARY OF THE INVENTION

It is an objective of the invention to provide a simple shutdown device that can safely and entirely turn off all or some predetermined apparatuses connected to a UPS system and finally safely shut down the power of the UPS itself. The invention also provides a corresponding method.

It is another objective of the invention to provide a main control computing device accompanied with a UPS with a safe power shut down function.

To achieve the above objectives, the invention provides a safe power shutdown device for a UPS system. The central feature is that it contains a switch module, a counting module, and a shutdown module. The switch module generates an OFF signal which is output to the central processing unit (CPU) of the UPS. After processing the OFF signal, the CPU sends out a first shutdown signal to external apparatuses to shut down the power of external apparatuses. The CPU then sends out a second shutdown signal to the counting module to begin counting. When the counting value reaches a predetermined time value, a third shutdown signal is output to the shutdown module. The shutdown module then processes the shutdown of the UPS itself according to the third shutdown signal.

The invention also provides a main control computing device, which is used with the UPS. The main control computing device has a shutdown signal processing module and a main control computing device shutdown module. The shutdown signal processing module receives the above-mentioned first shutdown signal and sends out a main control computing device shutdown signal to the main control computing device shutdown module to as to shut down the main control computing device.

### BRIEF DESCRIPTION OF THE DRAWINGS

The invention will become more fully understood from the detailed description given in the herein below illustration only, and thus are not limitative of the invention, and wherein:

FIG. 1 is a block diagram showing the composition of a conventional UPS;

FIG. 2 is a block diagram showing the safe shutdown device and UPS of the invention;

FIG. 3 is a schematic view showing the combination of the safe shutdown device of equipment connecting to the UPS and external apparatuses according to the invention;

FIG. 4 is a block diagram showing the combination of the safe shutdown device of equipment connecting to the UPS and external apparatuses in FIG. 3;

FIG. 5 is a flowchart outlining the procedure of shutting down external apparatuses using the disclosed safe shutdown device;

FIG. 6 is a block diagram showing a local composition of the main control computing device used in the disclosed UPS;

FIG. 7 is a flowchart showing the actions of the main control computing device in the process of safely shutting down the power; and

FIG. 8 is a flowchart showing the main steps in the method of safely turning off the power of equipment connecting to the UPS according to the invention.

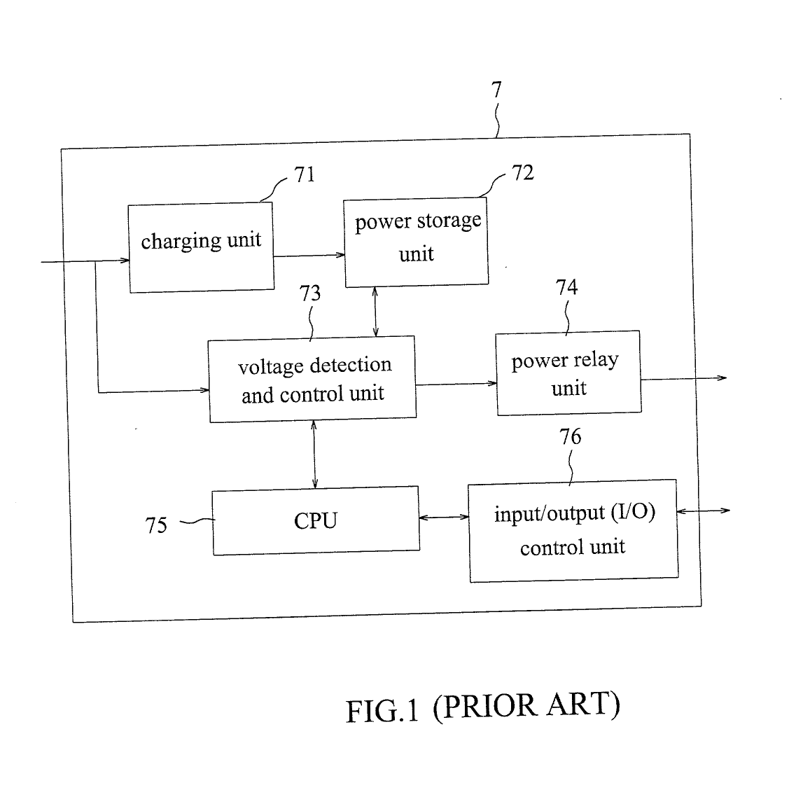

In the various drawings, the same references relate to the same elements.

### DETAILED DESCRIPTION OF THE INVENTION

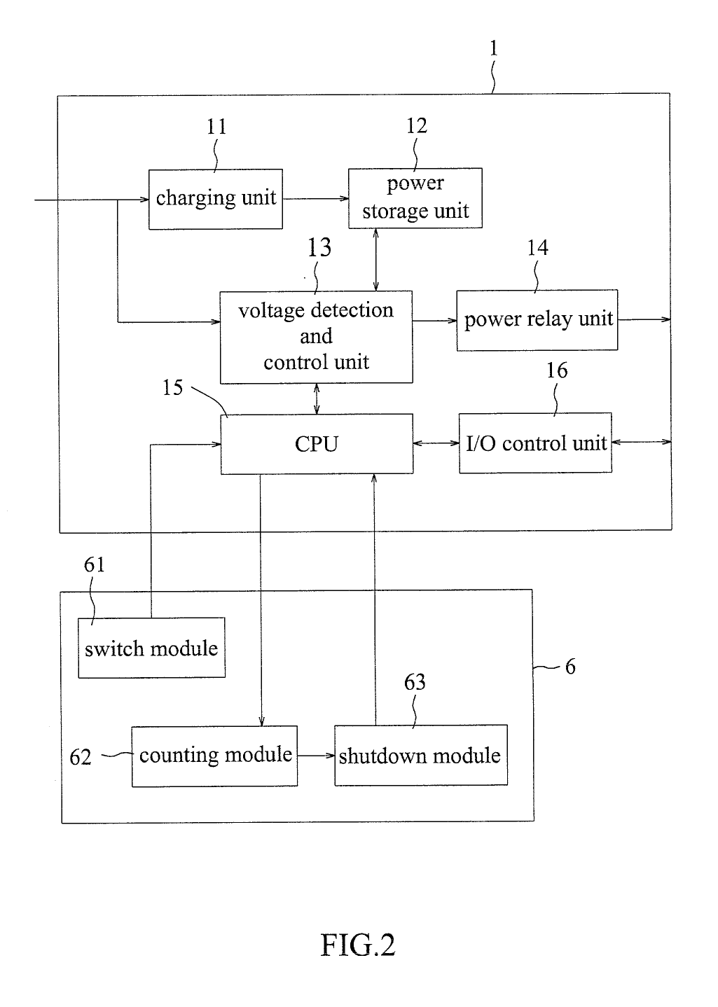

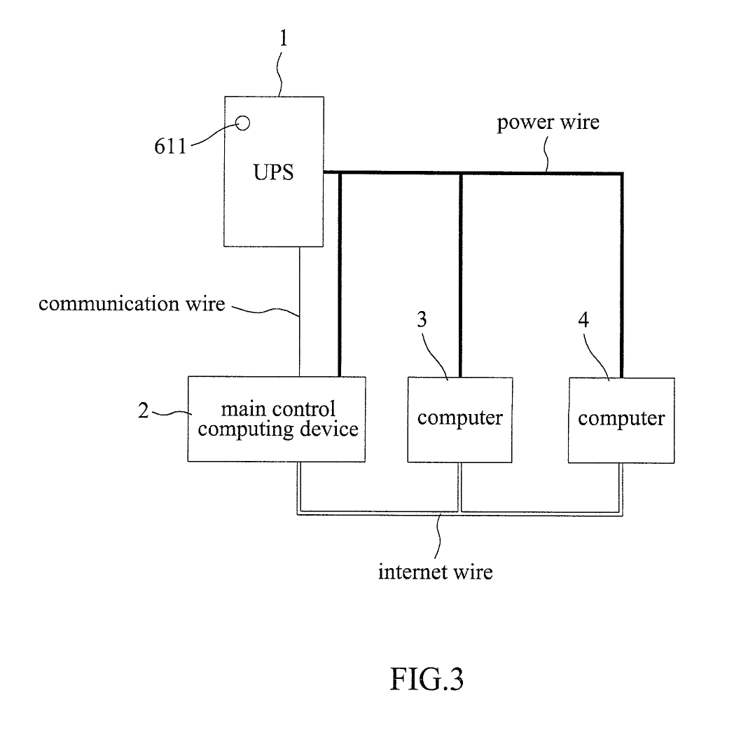

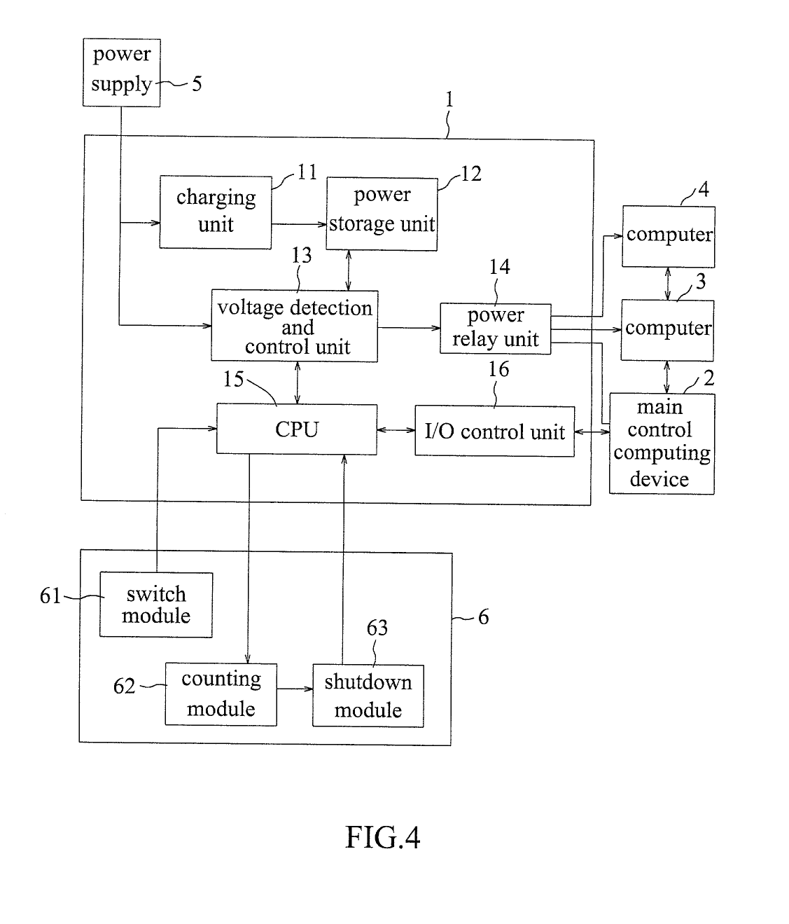

With reference to FIG. 2, an uninterruptible power supply (UPS) I includes a charging unit 11, a power storage unit 12, a voltage detection and control unit 13, a power relay unit 14, a central processing unit (CPU) 15, and an input/output (I/O) control unit 16. The charging unit 11 connects to an external power supply 5 (FIG. 4) and charges the power storage unit 12. The voltage detection and control unit 13 connects to the power supply to detect the input voltage of the power supply 5. The detection result is transmitted to the CPU 15. The CPU controls the voltage detection and control unit 13 according to the detection results so as to output the power stored in the power storage unit 12 to external equipment through the power relay unit 14. As shown in FIGS. 3 and 4, the external equipment in the current embodiment includes a main control computing device 2 and two computers 3, 4. In general, the equipment can have more than two computers or other apparatuses. The I/O control unit 16 transmits information between the external equipment and the UPS. In this embodiment, the I/O control unit 16 can be an RS-232 I/O unit or a network interface unit complying with the simple network management protocol (SNMP) or the hypertext transmission protocol (HTTP).

As also shown in FIG. 2, a safe shutdown device 6 of the invention includes a switch module 61, a counting module 62, and a shutdown module 63. The shutdown module 61 generates a shutdown signal and outputs it to the CPU 15. After being processed by the CPU 15, the shutdown signal is converted by the I/O control unit 16 into a first shutdown signal and output to the external equipment so as to shut down the external equipment. In the current embodiment, the shutdown module 61 is an ON/OFF switch device, which has a switch button 611 installed on the UPS 1 (FIG. 3). When the user presses the switch button 611, an OFF signal is generated. Of course, the switch module 61 can be a liquid crystal display touch-control switch device (not shown in the drawings) or a remote controlled signal receiver.

After the CPU 15 receives the OFF signal, it sends a second shutdown signal to the counting module 62 to begin counting and generate counting values. When a counting value coincides with a predetermined time value, a third shutdown signal is transmitted to the shutdown module 63. It is worth mentioning that the predetermined time can be the time needed to safely shut down all the external equipment connecting to the UPS. This value can be stored in the counting module 62 in advance or be provided by the external main control computing device 2 (to be described later).

The shutdown module 63 generates a power supply shutdown signal in response to the third shutdown signal and outputs it to the CPU 15. The CPU 15 then turns of the UPS.

It is appropriate to comment here that the safe shutdown device 6 of the invention can be directly installed on the UPS 1 so that the UPS 1 has the safe shutdown function (as shown in FIG. 3). Of course, the safe shutdown device 6 of the invention can be an independent device that electrically connects to the UPS 1 (as shown in FIG. 2) so as to enable the safe shutdown function thereon.

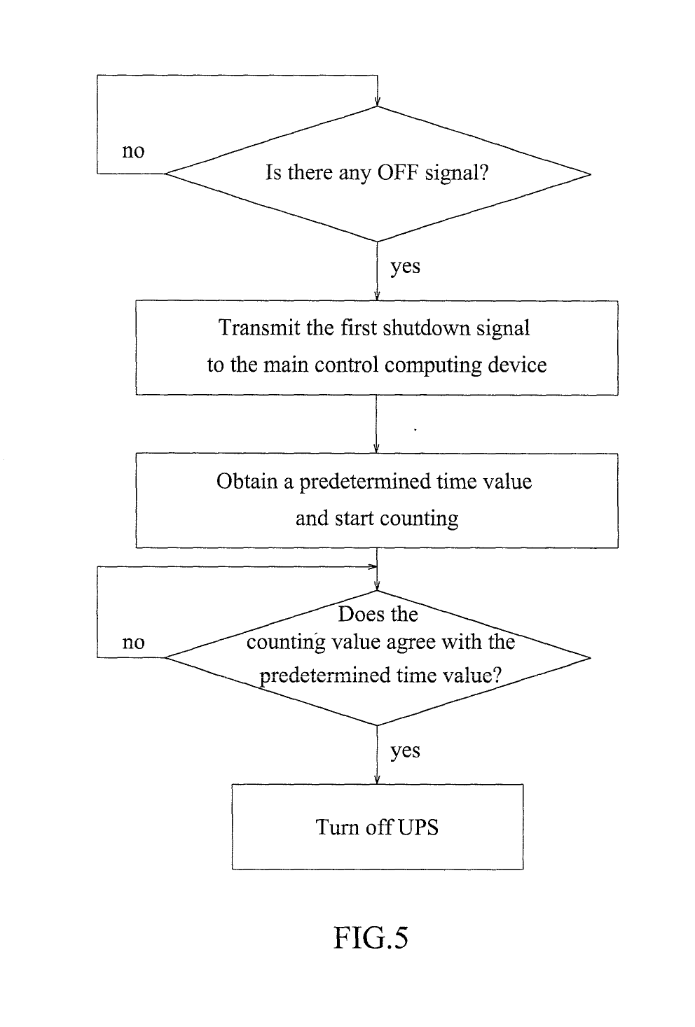

Please refer to FIG. 5 for an explanation of the safe shutdown procedure using the safe shutdown device 6 of the invention. As shown in the drawing, the UPS 1 uses the CPU 15 to receive the OFF signal generated by the switch module 61 at any time. If it receives an OFF signal, it immediately transmits a first shutdown signal to the main control computing device 2 through the I/O control unit 16. When the main control computing device 2 receives the first shutdown signal, it returns a predetermined time value through the I/O control unit 16 again. At the same moment, the CPU 15 generates a second shutdown signal to start the counting module 62 to compare whether the counting value agrees with the predetermined time value. If they agree, then a third shutdown signal is generated and transmitted to the shutdown module 63. The shutdown module 63 then produces a power supply shutdown signal in response to the third shutdown signal and outputs it to the CPU 15 for the CPU 15 to turn off the UPS 1. In the current embodiment, the predetermined time value is provided by the main control computing device 2. The user can reset the predetermined time value at will. Alternatively, the main control computing device 2 can compute its value according to the return values from other external equipment. The computation result is then output to the counting module 62.

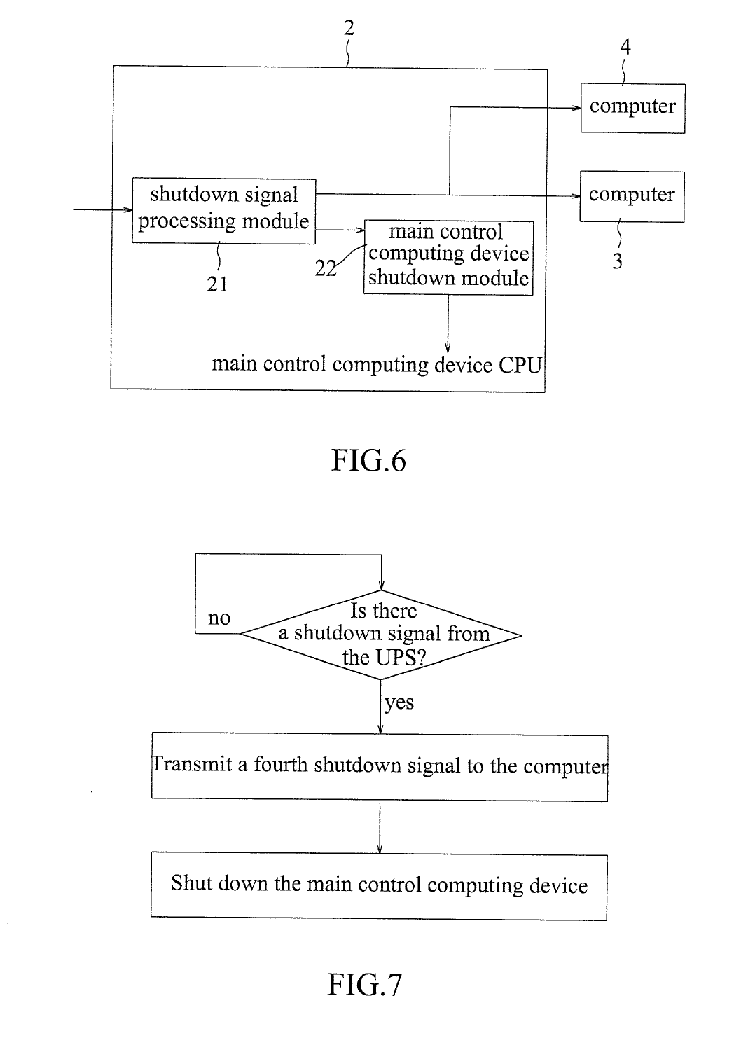

Please refer to FIGS. 6 and 7 for a detailed explanation of the main control computing device used in company with the UPS of the invention. Before going into the details of the main control computing device, it suffices to say that the main control computing device is a computer device. Therefore, the basic composition of the main control computing device (i.e., a computer) is omitted from the specification.

As shown in FIG. 6, the main control computing device 2 of the invention has a shutdown signal processing module 21 and a main control computing device shutdown module 22. The shutdown signal processing module 21 receives the first shutdown signal and sends out a fourth shutdown signal and a main control computing shutdown signal accordingly. The fourth shutdown signal is output to other connected external apparatuses so as to shut down those external apparatuses (computers 3, 4). The main control computing shutdown signal is output to the main control computing shutdown module to turn off the main control computing device. More explicitly, the main control computing shutdown signal is input to the main control computing device shutdown module 22, which transmits the main control computing device shutdown signal to the CPU of the main control computing device. The CPU of the main control computing device then turns off the main control computing device 2.

Referring to FIG. 7, after receiving the first shutdown signal sent out from the UPS 1, the main control computing device 2 immediately sends out a fourth shutdown signal to the external computers 3, 4. Finally, through the action of the main control computing device shutdown module 22, the main control computing device 2 is turned off.

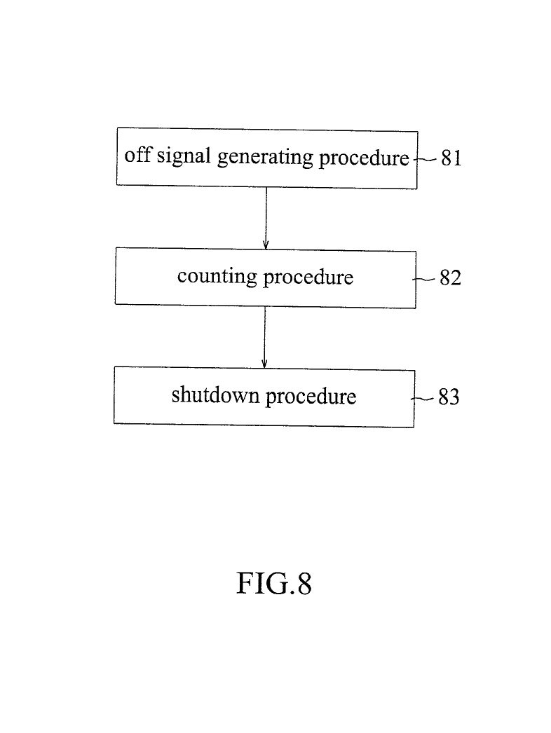

With simultaneous reference to FIGS. 5 and 8, the method for safely shutting down a UPS system according to the invention includes an OFF signal generating procedure 81, a counting procedure 82, and a shutdown procedure 83. The OFF signal generating procedure 81 generates an OFF signal and outputs it to the CPU 15 of the UPS 1. After the OFF signal is processed by the CPU 15, a first shutdown signal is sent out to the external apparatuses connecting to the UPS 1 to turn off the external apparatuses. After the CPU 15 receives the OFF signal, the CPU 15 sends out a second shutdown signal to start the counting procedure 82. When the counting value coincides with a predetermined time value, a third shutdown signal is produced. The shutdown procedure receives the third shutdown signal and turns off the UPS 1 itself accordingly.

To conclude, since the safe shutdown device of the equipment connecting to the UPS can generate an OFF signal in the shutdown module 61 and will turn itself off after a predetermined time (after the external equipment is totally shut down), therefore the invention can swiftly and safely turn off all equipment connected to the UPS and finally itself in a simple way. In other words, taking FIG. 3 as an example, the user needs only to press the switch button 611 of the ON/OFF switch device in order to turn off the main control computing device 2 and the computers 3, 4. Afterwards, the UPS 1 immediately turns itself off.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A safe shutdown device for an uninterruptible power supply (UPS) system, which comprises:
a switch module, which generates an OFF signal and outputs the OFF signal to a central processing unit (CPU) built in the UPS, the CPU generating a first shutdown signal and a second shutdown signal and transmitting the first shutdown signal to external apparatuses connected to the UPS after the OFF signal being processed by the CPU so as to shut down the external apparatuses;
a counting module, which starts counting after receiving the second shutdown signal sent out from the CPU that receives the OFF signal and outputs a third shutdown signal when a counting value coincides with a predetermined time value is generated; and
a shutdown module, which receives the third shutdown signal and turns off the UPS in response to the third shutdown signal.

2. The safe shutdown device for a UPS system of claim 1, wherein the safe shutdown device is installed in the UPS.

3. The safe shutdown device for a UPS system of claim 1, wherein the safe shutdown device is electrically connected to the UPS.

4. The safe shutdown device for a UPS system of claim 1, wherein the external apparatuses comprises more than one computer.

5. The safe shutdown device for a UPS system of claim 1, wherein the external apparatuses comprises more than one main control computing device.

6. The safe shutdown device for a UPS system of claim 1, wherein the external apparatuses comprises a main control computing device and more than one other external devices.

7. The safe shutdown device for a UPS system of claim 1, wherein the switch module is an ON/OFF switch device.

8. The safe shutdown device for a UPS system of claim 1, wherein the switch module is a liquid crystal touch-control switch device.

9. The safe shutdown device for a UPS system of claim 1, wherein the switch module is a remote controlled receiver.

10. The safe shutdown device for a UPS system of claim 1, wherein the predetermined time value is preset in the counting module.

11. The safe shutdown device for a UPS system of claim 5, wherein the main control computing device has a shutdown signal processing module and a main control computing shutdown module, the shutdown signal processing module receiving the first shutdown signal and sending out a fourth shutdown signal and a main control computing shutdown signal, the fourth shutdown signal being output to other external apparatuses in the connection so as to shut down the external apparatuses, and the main control computing shutdown signal being output to the main control computing shutdown module to turn off the main control computing device.

12. The safe shutdown device for a UPS system of claim 6, wherein the first shutdown signal is output to the main control computing device, which then sends out a fourth shutdown signal to at least one other external apparatus in connection to shut down the power.

13. The safe shutdown device for a UPS system of claim 1, wherein the predetermined time value is preset in the main control computing device and will be output to the counting module when the main control computing device receives the first shutdown signal.

14. The safe shutdown device for a UPS system of claim 1, wherein the predetermined time value is computed by the main control computing device according to the shutdown times returned from other external apparatuses after the main control computing device receives the first shutdown signal and the computation result is output to the counting module.

15. The safe shutdown device for a UPS system of claim 5, wherein the predetermined time value is preset in the main control computing device and will be output to the counting module when the main control computing device receives the first shutdown signal.

16. The safe shutdown device for a UPS system of claim 5, wherein the predetermined time value is computed by the main control computing device according to the shutdown times returned from other external apparatuses after the main control computing device receives the first shutdown signal and the computation result is output to the counting module.

17. A method for safely shutting down a UPS system, which comprises:
an OFF signal generating procedure in which an OFF signal is generated and output to a CPU of the UPS, and a first shutdown signal is sent out to the external apparatuses connecting to the UPS after the OFF signal is processed by the CPU so as to shut down the external apparatuses;
a counting procedure, in which the CPU sends out a second shutdown signal to start counting after receiving the OFF signal, and a third shutdown signal is generated when a counting value generated by counting coincides with a predetermined time value; and
a shutdown procedure, in which the third shutdown signal is received and processed to turn off the UPS.
